(19) United States
(12) Patent Application Publication
(10) Pub. No.: US 2026/0175585 A1
(43) Pub. Date: Jun. 25, 2026

(54) LIQUID DISCHARGE APPARATUS AND IMAGE FORMING APPARATUS

(71) Applicants: Naoto UEDA, Kanagawa (JP); Tomoaki MURAKAMI, Kanagawa (JP)

(72) Inventors: Naoto UEDA, Kanagawa (JP); Tomoaki MURAKAMI, Kanagawa (JP)

(21) Appl. No.: 19/381,005

(22) Filed: Nov. 6, 2025

(30) Foreign Application Priority Data
Dec. 19, 2024 (JP) 2024-224214

(51) Int. Cl. B41J 2/17; B41J 11/00; B41J 25/00

(52) U.S. Cl. CPC B41J 2/1714; B41J 11/0022; B41J 25/001

(57) ABSTRACT

A liquid discharge apparatus includes a liquid discharge head and a cross flow fan. The liquid discharge head discharges a liquid, in a discharge direction, onto a medium, conveyed in a conveyance direction. The cross flow fan is disposed on an upstream side of the liquid discharge head in the conveyance direction. The cross flow fan includes a cylindrical rotary blade to generate flow of air to be blown onto the medium and a duct having an air inlet and an air outlet. The air inlet has an opening disposed on an upstream side of the cylindrical rotary blade in the conveyance direction, to take in the air from the air inlet toward the cylindrical rotary blade. The air outlet is disposed below the air inlet to blow the air toward the medium to form an air curtain on the upstream side of the liquid discharge head.

### CROSS-REFERENCE TO RELATED APPLICATION

This patent application is based on and claims priority pursuant to 35 U.S.C. § 119(a) to Japanese Patent Application No. 2024-224214, filed on Dec. 19, 2024, in the Japan Patent Office, the entire disclosure of which is hereby incorporated by reference herein.

### BACKGROUND

### Technical Field

The present disclosure relates to a liquid discharge apparatus and an image forming apparatus, in particular, to a liquid discharge apparatus that forms an air curtain toward a recording medium in front of a nozzle face facing the recording medium and an image forming apparatus including the liquid discharge apparatus.

### Related Art

In the related art, an inkjet printer, which is one type of liquid discharge apparatus, narrows a gap between an inkjet head and a recording medium as much as possible to enhance landing accuracy of liquid droplets, and conveys the inkjet head or the recording medium at a high speed to increase productivity.

### SUMMARY

The present disclosure described herein provides an improved liquid discharge apparatus including a liquid discharge head and a cross flow fan. The liquid discharge head has a nozzle face having multiple nozzles to discharge a liquid, in a discharge direction, from the multiple nozzles onto a medium, conveyed in a conveyance direction orthogonal to the discharge direction. The cross flow fan is disposed on an upstream side of the liquid discharge head in the conveyance direction. The cross flow fan includes a cylindrical rotary blade and a duct. The cylindrical rotary blade has a rotation axis extending in an axial direction orthogonal to the discharge direction and the conveyance direction. The cylindrical rotary blade generates flow of air to be blown onto the medium. The duct covers the cylindrical rotary blade and extends downward from the cylindrical rotary blade to the nozzle face to guide the air toward the medium. The duct has an air inlet and an air outlet. The air inlet has an opening disposed on an upstream side of the cylindrical rotary blade in the conveyance direction, to take in the air from the air inlet toward the cylindrical rotary blade. The air outlet is disposed below the air inlet to blow the air toward the medium to form an air curtain on the upstream side of the liquid discharge head in the conveyance direction.

Further, the present disclosure described herein provides an improved liquid discharge apparatus including a liquid discharge head, a carriage, and a cross flow fan. The liquid discharge head has a nozzle face having multiple nozzles to discharge a liquid, in a discharge direction, from the multiple nozzles onto a medium, conveyed in a conveyance direction orthogonal to the discharge direction. The carriage moves the liquid discharge head in a scanning direction orthogonal to the discharge direction and the conveyance direction. The cross flow fan is disposed on a downstream side of the liquid discharge head in the scanning direction. The cross flow fan includes a cylindrical rotary blade and a duct. The cylindrical rotary blade has a rotation axis extending in the conveyance direction. The cylindrical rotary blade generates flow of air to be blown onto the medium. The duct covers the cylindrical rotary blade and extends downward from the cylindrical rotary blade to the nozzle face to guide the air toward the medium. The duct has an air inlet and an air outlet. The air inlet has an opening disposed on the downstream side of the cylindrical rotary blade in the scanning direction, to take in the air from the air inlet toward the cylindrical rotary blade. The air outlet is disposed below the air inlet to blow the air toward the medium to form an air curtain on the downstream side of the liquid discharge head in the scanning direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a side view of a liquid discharge apparatus;

FIG. 1B is a side view of a liquid discharge apparatus according to a first modification;

FIG. 1C is a side view of a liquid discharge apparatus according to a second modification;

FIG. 1D is a side view of a liquid discharge apparatus according to a third modification;

FIG. 2 is a perspective view of a cross flow fan;

FIGS. 3A, 3B, and 3C are diagrams each illustrating deviation of landing positions due to an influence of an airflow;

FIGS. 4A and 4B are plan views of liquid discharge apparatuses having a single-head configuration and a multi-head configuration, respectively;

FIG. 5 is a plan view of an image forming apparatus in which a recording medium is conveyed in a direction orthogonal to a scanning direction of a liquid discharge head; and

FIGS. 6A and 6B are plan views of liquid discharge apparatuses according to a fourth modification and a fifth modification, respectively.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the related art, an inkjet printer, which is one type of liquid discharge apparatus, narrows a gap between an inkjet head and a recording medium as much as possible to enhance landing accuracy of liquid droplets, and conveys the inkjet head or the recording medium at a high speed to increase productivity. However, the gap between the inkjet head and the recording medium may be widened to some extent to use various types of media. When the inkjet head or the recording medium is conveyed at a high speed, such a gap may cause flight trajectories of the liquid droplets to deviate due to an influence of an airflow.

Accordingly, the landing accuracy of the liquid droplets may be lower, or the liquid droplets may break during the flight, deteriorating printing quality. In a comparative example, a liquid discharge apparatus forms an air curtain formed on the front, back, left, and right sides of a nozzle face to prevent the flight trajectories of the liquid droplets from being affected by the airflow.

However, a mist of liquid droplets may stay around the inkjet head, and the mist of liquid droplets may be sucked into an air inlet of a blower that forms an air curtain. Accordingly, the mist of liquid droplets may adhere to the recording medium, deteriorating the printing quality. In view of such a circumstance as described above, an object of the present disclosure is to prevent the mist of liquid droplets from being sucked into the air inlet of the blower for forming an air curtain.

A liquid discharge apparatus according to an embodiment of the present disclosure will be described below with reference to the drawings. It is to be understood that the liquid discharge apparatuses illustrated in the drawings are mere examples, and thus the present disclosure is not limited to the examples. Like reference signs are allocated to elements having a similar function or shape, and redundant descriptions thereof are omitted below.

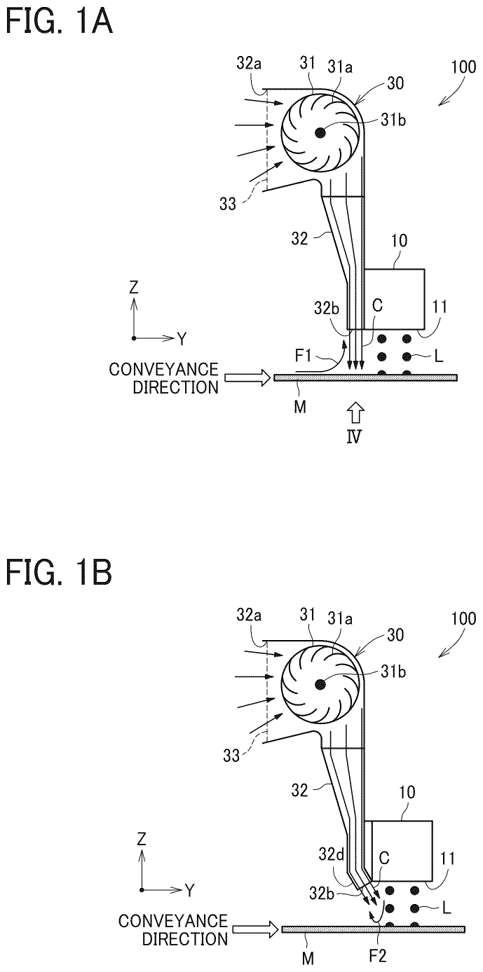

As illustrated in FIG. 1A, a liquid discharge apparatus 100 includes a liquid discharge head 10 and a cross flow fan 30 serving as a blower. The liquid discharge head 10 has a nozzle face 11 having multiple nozzles on the lower face thereof.

The nozzle face 11 faces a surface of a recording medium M, which may be referred to simply as a medium, in parallel with a gap. Liquid droplets are discharged from the multiple nozzles onto the recording medium M, and the liquid droplets form an image on the surface of the recording medium M.

Various methods such as a piezoelectric method, a thermal method, and an electrostatic method can be adopted to allow the liquid discharge head 10 to discharge the liquid droplets from the nozzles. In the piezoelectric method, a piezoelectric element is used to deform a diaphragm forming a wall face of a liquid channel to change a volume inside the liquid channel so as to discharge liquid droplets.

In the thermal method, a thermal resistor is used to heat a liquid in a liquid channel to generate bubbles so as to discharge liquid droplets using pressure generated by the bubbles. In the electrostatic method, an electrostatic force is generated between a diaphragm and an electrode to deform the diaphragm to change a volume inside a liquid channel so as to discharge liquid droplets.

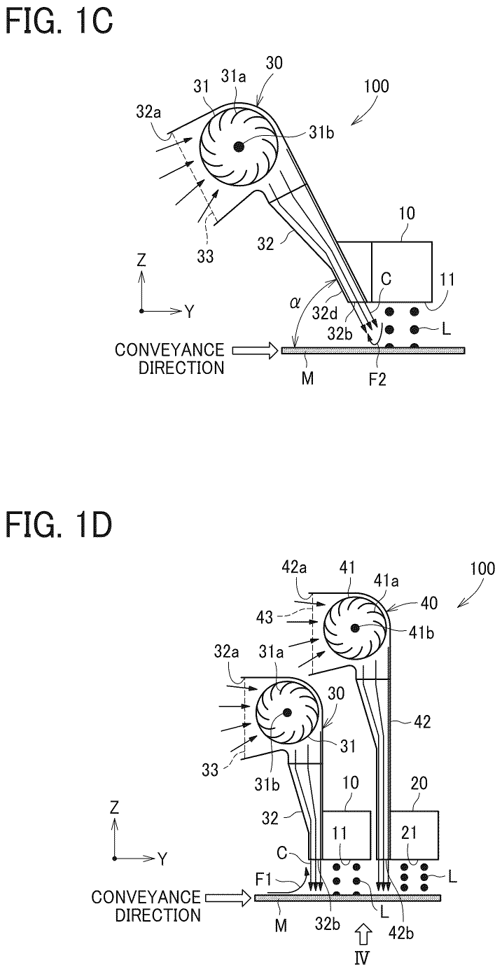

The cross flow fan 30 includes a cylindrical rotary blade 31 (impeller) and a duct 32 that generates and guides a flow of air. As illustrated in FIG. 2, the rotary blade 31 includes multiple blades 31a and a rotation shaft 31b. The multiple blades 31a extend in a longitudinal direction (i.e., an axial direction) of the rotary blade 31. The rotation shaft 31b is disposed at a center of the multiple blades 31a, and one end of the rotation shaft 31b is coupled to a motor Mo. The rotation shaft 31b serves as a rotation axis of the rotary blade 31 extending in the axial direction. The other end of the rotation shaft 31b is rotatably supported by an inner wall of the duct 32.

The duct 32 covers a periphery of the rotary blade 31. For example, the duct 32 may be integrally formed of a resin in a single body. The duct 32 extends downward in a vertical direction from the rotary blade 31 to guide air toward the recording medium M. An air inlet 32a is formed on one side (left side in FIG. 1A) of an upper end of the duct 32.

The air inlet 32a is directed toward an upstream side (front side of the liquid discharge head 10) in a conveyance direction of the recording medium M. In other words, the air inlet 32a has an opening facing upstream in the conveyance direction to take in air toward the cylindrical rotary blade 31. In yet other words, the opening of the air inlet 32a is disposed on the upstream side of the rotary blade 31 in the conveyance direction. The conveyance direction is orthogonal to the axial direction. A space above the liquid discharge head 10 is limited due to, for example, a liquid (ink) pipe and a harness. Accordingly, the space makes it difficult to direct the air inlet 32a toward a downstream side in the conveyance direction of the recording medium M. A louver 33 is disposed at the air inlet 32a for safety. For example, the louver 33 with a mesh prevents dirt and dust particles from being sucked into the air inlet 32a.

A slit-shaped air outlet 32b is formed below the air inlet 32a and at a lower end of the duct 32 extending in the vertical direction toward the recording medium M. The air outlet 32b is disposed on an upstream side (in front) of the nozzle face 11 in the conveyance direction and on (or above) a plane extended from the nozzle face 11. Accordingly, the air outlet 32b does not hinder a wiper blade from wiping the nozzle face 11.

Regarding the term “front side (or in front of),” when the recording medium M is conveyed in the conveyance direction (a Y direction), an upstream side of the liquid discharge head 10 in the conveyance direction is referred to as the front side of the liquid discharge head 10 (the nozzle face 11), and a downstream side of the liquid discharge head 10 in the conveyance direction is referred to as a back side of the liquid discharge head 10 (the nozzle face 11).

When the nozzle face 11 is to be wiped, a drive voltage having such a voltage waveform that does not cause liquid droplets to be discharged from the nozzles but allows a liquid (ink) to sufficiently wet the nozzle face 11 is applied to a piezoelectric element of the liquid discharge head 10. Since the wiper blade moves along the nozzle face 11 which is sufficiently wetted with the liquid (ink), the wiper blade can remove (wipe) adhered substances on the nozzle face 11 without damaging the nozzle face 11.

While the recording medium M is conveyed in the Y direction indicated by the outlined arrow illustrated in FIG. 1A, liquid droplets L are discharged from the nozzle face 11 to form an image on the surface of the recording medium M. A Z direction is a height direction of the liquid discharge apparatus 100, and an X direction in FIGS. 2, 4A, 4B, 6A, and 6B is a width direction of the liquid discharge apparatus 100.

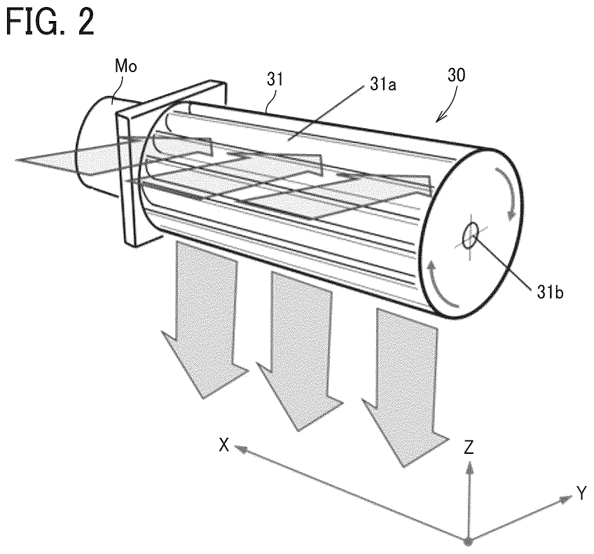

An airflow F1 is generated as the recording medium M is conveyed in the Y direction. When the recording medium M is stationary, as illustrated in FIG. 3A, the liquid droplets L discharged from the nozzle face 11 in a discharge direction (i.e., the −Z direction) precisely and vertically land on ideal positions on the surface of the recording medium M.

When the recording medium M is conveyed in the Y direction, as illustrated in FIG. 3B, however, the airflow F1 is generated along the surface of the recording medium M by the conveyance of the recording medium M. Due to an influence of the airflow F1, the flight trajectories of the liquid droplets L deviate rightward as illustrated in FIG. 3B. Since another airflow F2 is generated along the flight trajectories of the liquid droplets L, the flight trajectories of the liquid droplets L also deviate rightward as illustrated in FIG. 3C due to an influence of the airflow F2.

In the present embodiment, as illustrated in FIG. 1A, air blown out of the air outlet 32b, which is disposed at the lower end of the duct 32, forms an air curtain C. The air curtain C is formed in the vertical direction on the upstream side (in front) of the nozzle face 11 in the conveyance direction.

The air curtain C blocks the airflow F1 generated along the surface of the recording medium M. As a result, the flight trajectories of the liquid droplets L are not affected by the influence of the airflow F1. Accordingly, the liquid droplets L discharged from the nozzle face 11 precisely and vertically land on ideal positions on the surface of the recording medium M. The cross flow fan 30 can blow air with a uniform air volume and a constant wind speed in an array direction of the nozzles to effectively prevent the flight trajectories of the liquid droplets from being affected by the airflows F1 and F2 and effectively prevent the liquid droplets from breaking during the flight.

FIG. 1B illustrates a first modification in which an orientation of the air outlet 32b of the duct 32 is inclined rearward with respect to the nozzle face 11 in the conveyance direction of the recording medium M (toward a back side of the nozzle face 11). In other words, the duct 32 has an outlet portion (bent portion) 32d having the air outlet 32b on the bottom thereof, and the outlet portion 32d is bent from a portion of the duct 32 other than the outlet portion 32d to incline the outlet portion 32d downstream in the conveyance direction with respect to the nozzle face 11. In yet other words, the duct 32 has the outlet portion (bent portion) 32d having the air outlet 32b on a bottom of bent portion 32d and bent at a lower end of the duct 32, and the outlet portion (bent portion) 32d blows the air in a blowing direction inclined with respect to the discharge direction and toward a downstream side of the cylindrical rotary blade 31 in the conveyance direction. The air curtain C cancels the influence of the airflow F2 to prevent the flight trajectories of the liquid droplets from deviating as illustrated in FIG. 3C due to the airflow F2 generated along the flight trajectories of the liquid droplets L.

As illustrated in FIG. 1B, the orientation of the air outlet 32b at the lower end of the duct 32 can be inclined by changing the shape of the lower end (i.e., the outlet portion 32d) of the duct 32. In other words, the orientation of the air inlet 32a of the duct 32 is not changed at all. Such a configuration prevents the mist of liquid droplets that are generated behind (right side in FIG. 1B) the liquid discharge head 10 from being sucked into the air inlet 32a. Further, a posture of the duct 32 is not changed. Such a configuration enhances efficiency of the space for, for example, the pipe and the harness above the liquid discharge head 10.

FIG. 1C is a second modification in which the entire duct 32 is inclined upstream in the conveyance direction at an angle α. In other words, the duct 32 has the outlet portion 32d having the air outlet 32a, and the duct 32 is inclined upstream in the conveyance direction from the air outlet 32b to incline the outlet portion 32d downstream in the conveyance direction with respect to the nozzle face 11. Due to such a configuration, the orientation of the air outlet 32b (i.e., the outlet portion 32d) can be inclined downstream (rearward) with respect to the nozzle face 11 in the conveyance direction of the recording medium M (toward the back side of the nozzle face 11). Similarly to FIG. 1B, in FIG. 1C, the outlet portion 32d blows the air in the blowing direction inclined with respect to the discharge direction and toward the downstream side of the cylindrical rotary blade 31 in the conveyance direction.

As described above, the orientation of the air outlet 32b can be inclined by inclining the entire duct 32 forward from the air outlet 32b without changing the shape of the duct 32 itself at all, and with low cost. The air inlet 32a of the duct 32 inclined forward and downward as illustrated in FIG. 1C prevents the mist of liquid droplets generated and diffused rearward and upward of the liquid discharge head 10 from being sucked into the air inlet 32a. The cross flow fan 30, which is swingable (adjustable in angle α) about the air outlet 32b of the duct 32, can support various conveyance speeds, liquid droplet speeds, air volumes, and wind speeds of the recording medium M.

FIG. 1D illustrates the liquid discharge apparatus 100 according to a third modification in which the liquid discharge head 10 and a liquid discharge head 20 are disposed in a two stage (tandem) manner on the front side and the back side in the conveyance direction of the recording medium M. The liquid discharge apparatus 100 having a multi-head configuration as described above enhances productivity.

In the liquid discharge apparatus 100 having the multi-head configuration, the cross flow fan 30 and a cross flow fan 40 are provided for the liquid discharge heads 10 and 20, respectively. The cross flow fan 40 on the back side is substantially identical in structure to the cross flow fan 30 on the front side except that a length in the longitudinal direction of a duct 42 is longer than a length in the longitudinal direction of the duct 32 of the cross flow fan 30 on the front side.

An air inlet 42a of the duct 42 is positioned above the air inlet 32a of the cross flow fan 30 on the front side. As a result, the cross flow fan 30 on the front side does not hinder air from entering the air inlet 42a of the duct 42 on the back side.

An air outlet 42b of the cross flow fan 40 on the back side is also disposed in front of a nozzle face 21 and on (or above) a plane extended from the nozzle face 21. Accordingly, the air outlet 42b does not hinder the wiper blade from wiping the nozzle face 21.

A rotary blade 41, multiple blades 41a, a rotation shaft 41b, and a louver 43 have the same structure as those of the cross flow fan 30 on the front side. In FIG. 1D, the air outlets 32b and 42b may be inclined as illustrated in FIGS. 1B and 1C.

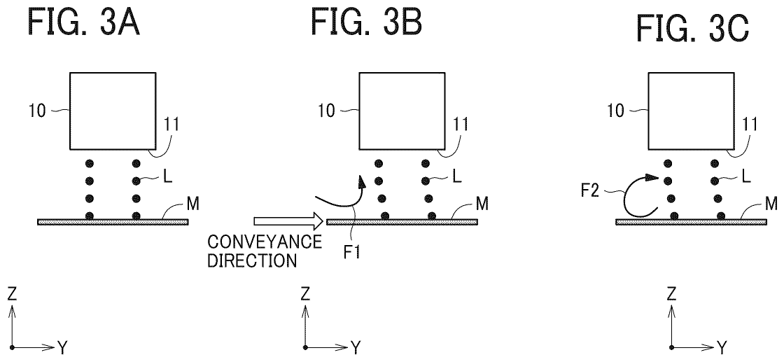

FIGS. 4A and 4B are plan views of the liquid discharge apparatus 100 having the single-head configuration and the liquid discharge apparatus 100 having the multi-head configuration as viewed from a side (lower side) of the nozzle faces 11 and 21, respectively. FIG. 4A illustrates the single-head configuration, and FIG. 4B illustrates the multi-head configuration. As illustrated in FIGS. 4A and 4B, the air outlet 32b is positioned in front of each of the nozzle faces 11 and 21.

A width of the air outlet 32b in the X direction is larger than a length of each of arrays of nozzles 12 and 22 on the nozzle faces 11 and 21. As a result, an air curtain can effectively prevent an influence of an airflow on flight trajectories of the liquid droplets.

In a case of the multi-head configuration illustrated in FIG. 4B, the duct 32 of one cross flow fan 30 is divided into four branch ducts connected to four air outlets 32b to distribute air to the four air outlets 32b via the branch ducts and blow out the air from the four air outlets 32b. Such a configuration forms an air curtain in front of each of the nozzle faces 11 and 21. Branch ducts of the duct 32 achieve a cost reduction of the liquid discharge apparatus 100 having the multi-head configuration.

There are two types of image forming apparatuses: a so-called line type image forming apparatus and a serial type image forming apparatus. The liquid discharge apparatus 100 described above is applicable to a line type image forming apparatus in which the recording medium M is conveyed in the Y direction by a conveyor. The line type image forming apparatus uses a head (line head) having a length (recording width) between a nozzle at one end and a nozzle at the other end equal to or longer than a width of sheet (i.e., the recording medium M).

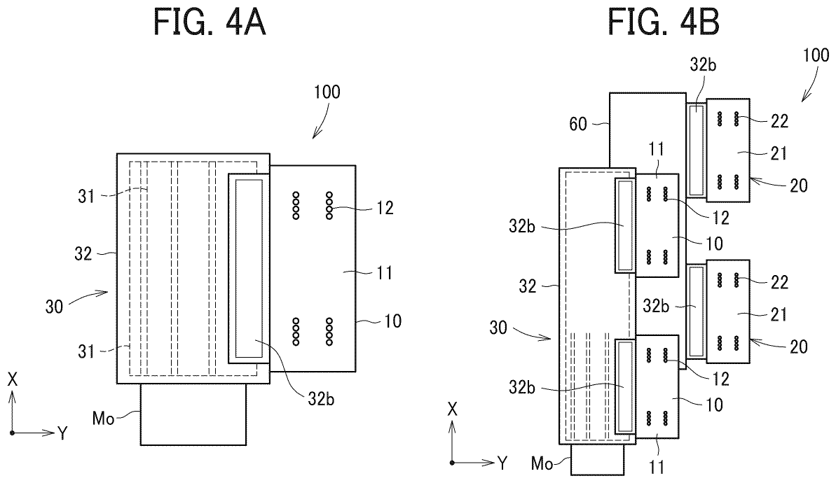

FIG. 5 is a serial type image forming apparatus in which the recording medium M is conveyed in a direction orthogonal to a scanning direction of the liquid discharge head 10 by a conveyor. A serial type image forming apparatus uses a head (serial head) having a recording width shorter than the recording width of the line head.

A pair of left and right guide rails 50 extends in a direction orthogonal to the conveyance direction of the recording medium M. A carriage 60 is movably attached to the pair of left and right guide rails 50. The liquid discharge head 10 is mounted on the carriage 60. When liquid droplets are to be discharged, the conveyance of the recording medium M is temporarily stopped.

In this case, the air inlet 32a of the cross flow fan 30 is disposed in front of (on a downstream side of) the liquid discharge head 10 in the scanning direction indicated by the outlined arrow in FIG. 5. As a result, such a configuration prevents the mist of liquid droplets generated behind (lower side in FIG. 5) the liquid discharge head 10 from being sucked into the air inlet 32a.

When the liquid discharge head 10 discharges liquid droplets while reciprocally moving, the cross flow fan 30 and the duct 32 may be installed on an opposite side of the liquid discharge head 10 illustrated in FIG. 5. Alternatively, air is distributed from one cross flow fan 30 into two branch ducts of the duct 32, one of which is connected to an air outlet 32b on the opposite side to blow the air from the cross flow fan 30 to the air outlets 32b on both the front side and the opposite side (back side) in the scanning direction. Valves may be provided for the branch ducts, and the valves are opened or closed depending on a moving direction of the liquid discharge head 10 to blow air from one of the air outlets 32b on the front side and the opposite side to form an air curtain on the front side or the opposite side of the liquid discharge head 10.

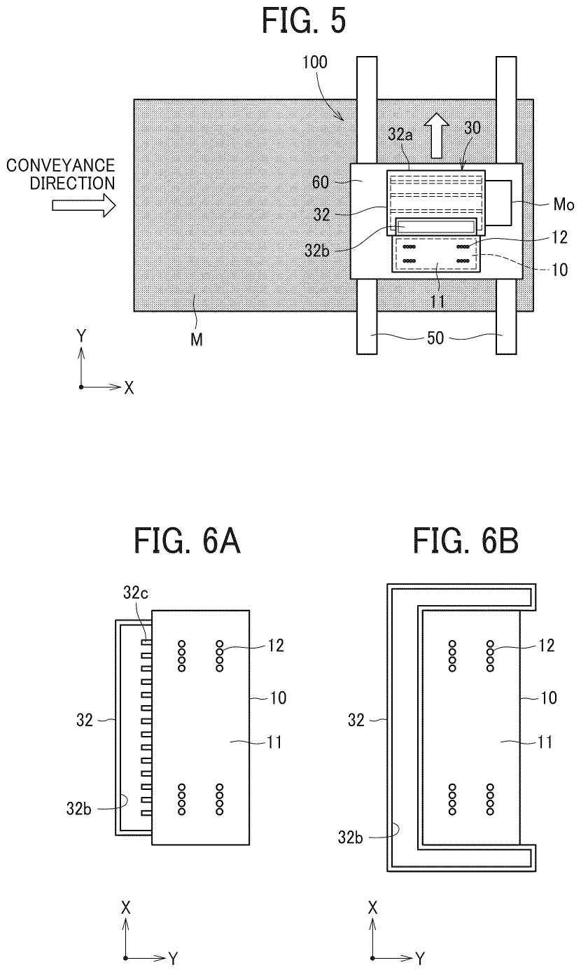

FIGS. 6A and 6B illustrate other modifications. FIG. 6A illustrates a fourth modification in which multiple ribs 32c extend in a direction of air flowing in the duct 32 on an inner face of the duct 32. The multiple ribs 32c are disposed at equal intervals in a width direction of the duct 32 (i.e., the X direction).

The multiple ribs 32c extend in the longitudinal direction of the duct 32 (i.e., the Z direction). Preferably, the multiple ribs 32c extend to the air outlet 32b. The ribs 32c can rectify the flow of air in the duct 32 to form an air curtain at a constant wind speed in the width direction.

Such a configuration effectively prevents the flight trajectories of the liquid droplets L from deviating due to the airflows F1 and F2 illustrated in FIGS. 3B and 3C. The multiple ribs 32c also increase the rigidity of the duct 32.

FIG. 6B illustrates a fifth modification in which the air outlet 32b of the duct 32 has a U shape surrounding the front, left, and right sides of the nozzle face 11. The duct 32 illustrated in FIG. 6B can form a U-shaped air curtain, and the U-shaped air curtain can further prevent the flight trajectories of the liquid droplets from deviating.

Although the embodiments of the present disclosure have been described above, embodiments of the present invention are not limited to the embodiments described above, and a variety of modifications can naturally be made within the scope of the technical idea described in the scope of the appended claims. In the liquid discharge apparatus 100 having the multi-head configuration illustrated in FIG. 4B, for example, switch valves may be installed in the branch ducts of the duct 32 of the cross flow fan 30. By opening or closing the switch valves, the switch valve can stop supplying air to the air outlet 32b of the head that has been stopped, and thus the air of the cross flow fan 30 can be effectively used. Ink in the head that has been stopped can be prevented from drying due to an air curtain. An exclusive cross flow fan 30 may be provided for each head of the liquid discharge apparatus 100 having the multi-head configuration illustrated in FIG. 4B.

The following describes aspects of the present disclosure.

### Aspect 1

According to Aspect 1, a liquid discharge apparatus includes (mounts) a liquid discharge head. The liquid discharge head is movably held in a scanning direction and has multiple nozzles formed on a nozzle face facing a recording medium. The liquid discharge head includes a cross flow fan serving as a blower that forms an air curtain toward the recording medium in front of the nozzle face in the scanning direction while liquid droplets are discharged from the multiple nozzles toward the recording medium. The cross flow fan includes a cylindrical rotary blade and a duct. The rotary blade has an axis in a direction orthogonal to the scanning direction and parallel to the recording medium. The duct covers a periphery of the rotary blade and is disposed to guide a flow of air from the rotary blade to the nozzle face. The duct has a suction port (air inlet) for sucking air toward the rotary blade and a blowout port (air outlet) for blowing out the air curtain. The suction port is opened in front of the rotary blade in the scanning direction.

In other words, a liquid discharge apparatus includes a liquid discharge head and a cross flow fan. The liquid discharge head has a nozzle face having multiple nozzles to discharge a liquid, in a discharge direction, from the multiple nozzles onto a medium, conveyed in a conveyance direction orthogonal to the discharge direction. The cross flow fan is disposed on an upstream side of the liquid discharge head in the conveyance direction. The cross flow fan includes a cylindrical rotary blade and a duct. The cylindrical rotary blade has a rotation axis extending in an axial direction orthogonal to the discharge direction and the conveyance direction. The cylindrical rotary blade generates flow of air to be blown onto the medium. The duct covers the cylindrical rotary blade and extends downward from the cylindrical rotary blade to the nozzle face to guide the air toward the medium. The duct has an air inlet and an air outlet. The air inlet has an opening disposed on an upstream side of the cylindrical rotary blade in the conveyance direction, to take in the air from the air inlet toward the cylindrical rotary blade. The air outlet is disposed below the air inlet to blow the air toward the medium to form an air curtain on the upstream side of the liquid discharge head in the conveyance direction.

Alternatively, a liquid discharge apparatus includes a liquid discharge head, a carriage, and a cross flow fan. The liquid discharge head has a nozzle face having multiple nozzles to discharge a liquid, in a discharge direction, from the multiple nozzles onto a medium, conveyed in a conveyance direction orthogonal to the discharge direction. The carriage moves the liquid discharge head in a scanning direction orthogonal to the discharge direction and the conveyance direction. The cross flow fan is disposed on a downstream side of the liquid discharge head in the scanning direction. The cross flow fan includes a cylindrical rotary blade and a duct. The cylindrical rotary blade has a rotation axis extending in the conveyance direction. The cylindrical rotary blade generates flow of air to be blown onto the medium. The duct covers the cylindrical rotary blade and extends downward from the cylindrical rotary blade to the nozzle face to guide the air toward the medium. The duct has an air inlet and an air outlet. The air inlet has an opening disposed on the downstream side of the cylindrical rotary blade in the scanning direction, to take in the air from the air inlet toward the cylindrical rotary blade. The air outlet is disposed below the air inlet to blow the air toward the medium to form an air curtain on the downstream side of the liquid discharge head in the scanning direction.

### Aspect 2

According to Aspect 2, in the liquid discharge apparatus of Aspect 1, the blowout port is disposed on an extension of the nozzle face.

In other words, the air outlet is disposed on or above a plane extended from the nozzle face in the conveyance direction.

Alternatively, the air outlet is disposed on or above a plane extended from the nozzle face in the scanning direction.

### Aspect 3

According to Aspect 3, in the liquid discharge apparatus of Aspect 1 or Aspect 2, the blowout port is inclined toward the nozzle face of the liquid discharge head.

In other words, the duct has a bent portion having the air outlet on a bottom of bent portion and bent at a lower end the duct. The bent portion blows the air in a blowing direction inclined with respect to the discharge direction and toward a downstream side of the cylindrical rotary blade in the conveyance direction.

Alternatively, the duct has a bent portion having the air outlet on a bottom of bent portion and bent at a lower end the duct. The bent portion blows the air in a blowing direction inclined with respect to the discharge direction and toward an upstream side of the cylindrical rotary blade in the scanning direction.

### Aspect 4

According to Aspect 4, in the liquid discharge apparatus of Aspect 1 or Aspect 2, the entire duct is inclined forward in the scanning direction to allow the blowout port to be inclined toward the nozzle face of the liquid discharge head.

In other words, the duct has an outlet portion having the air outlet. The duct is inclined upstream in the conveyance direction from the air outlet to incline the outlet portion downstream in the conveyance direction with respect to the nozzle face.

Alternatively, the duct has an outlet portion having the air outlet. The duct is inclined downstream in the scanning direction from the air outlet to incline the outlet portion upstream in the scanning direction with respect to the nozzle face.

### Aspect 5

According to Aspect 5, in the liquid discharge apparatus of any one of Aspect 1 to Aspect 4, multiple liquid discharge heads including the liquid discharge head are disposed, and air from the one cross flow fan is distributed to each of the liquid discharge heads through branch ducts of the duct.

In other words, the liquid discharge apparatus according to any one of Aspect 1 to Aspect 4, further includes multiple liquid discharge heads including the liquid discharge head. The duct includes multiple branch ducts to distribute the air from the cross flow fan to the multiple liquid discharge heads via the multiple branch ducts.

### Aspect 6

According to Aspect 6, in the liquid discharge apparatus of any one of Aspect 1 to Aspect 5, multiple ribs are formed in a direction of a flow of air on an inner face of the duct.

In other words, the duct has multiple ribs on an inner face of the duct, and each of the multiple ribs extends in a direction of the air flowing in the duct.

### Aspect 7

According to Aspect 7, in the liquid discharge apparatus of Aspect 6, the multiple ribs are formed to reach the blowout port.

In other words, the multiple ribs extend to the air outlet.

### Aspect 8

According to Aspect 8, in the liquid discharge apparatus of any one of Aspect 1 to Aspect 7, the blowout port is formed on the front, left, and right sides of the nozzle face in the scanning direction.

In other words, the air outlet is disposed on the upstream side of the nozzle face in the conveyance direction and on both sides of the nozzle face in the axial direction.

Alternatively, the air outlet is disposed on the downstream side of the nozzle face in the scanning direction and on both sides of the nozzle face in the conveyance direction.

### Aspect 9

According to Aspect 9, a line type image forming apparatus includes the liquid discharge apparatus of any one of Aspect 1 to Aspect 8.

In other words, an image forming apparatus includes the liquid discharge apparatus according to any one of Aspect 1 to Aspect 8. The liquid discharge apparatus further includes a conveyor to convey the medium to the liquid discharge head in the conveyance direction.

### Aspect 10

According to Aspect 10, a serial type image forming apparatus includes the liquid discharge apparatus of any one of Aspect 1 to Aspect 8.

In other words, an image forming apparatus includes the liquid discharge apparatus according to any one of Aspect 1 to Aspect 8. The liquid discharge apparatus further includes a conveyor to convey the medium to the liquid discharge head in the conveyance direction and a guide rail extending in the scanning direction. The carriage is attached to the guide rail to move along the guide rail in the scanning direction.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge apparatus comprising:
a liquid discharge head having a nozzle face having multiple nozzles to discharge a liquid, in a discharge direction, from the multiple nozzles onto a medium, conveyed in a conveyance direction orthogonal to the discharge direction;
a cross flow fan on an upstream side of the liquid discharge head in the conveyance direction,
the cross flow fan including:
a cylindrical rotary blade having a rotation axis extending in an axial direction orthogonal to the discharge direction and the conveyance direction,
the cylindrical rotary blade to generate flow of air to be blown onto the medium; and
a duct covering the cylindrical rotary blade and extending downward from the cylindrical rotary blade to the nozzle face to guide the air toward the medium,
the duct having:
an air inlet having an opening disposed on an upstream side of the cylindrical rotary blade in the conveyance direction,
to take in the air from the air inlet toward the cylindrical rotary blade; and
an air outlet below the air inlet to blow the air toward the medium to form an air curtain on the upstream side of the liquid discharge head in the conveyance direction.

2. The liquid discharge apparatus according to claim 1,
wherein the air outlet is disposed on or above a plane extended from the nozzle face in the conveyance direction.

3. The liquid discharge apparatus according to claim 1,
wherein the duct has a bent portion:
having the air outlet on a bottom of bent portion; and
bent at a lower end the duct, and
the bent portion blows the air in a blowing direction:
inclined with respect to the discharge direction; and
toward a downstream side of the cylindrical rotary blade in the conveyance direction.

4. The liquid discharge apparatus according to claim 1,
wherein the duct has an outlet portion having the air outlet, and
the duct is inclined upstream in the conveyance direction from the air outlet to incline the outlet portion downstream in the conveyance direction with respect to the nozzle face.

5. The liquid discharge apparatus according to claim 1, further comprising multiple liquid discharge heads including the liquid discharge head,
wherein the duct includes multiple branch ducts to distribute the air from the cross flow fan to the multiple liquid discharge heads via the multiple branch ducts.

6. The liquid discharge apparatus according to claim 1,
wherein the duct has multiple ribs on an inner face of the duct, and
each of the multiple ribs extends in a direction of the air flowing in the duct.

7. The liquid discharge apparatus according to claim 6,
wherein the multiple ribs extend to the air outlet.

8. The liquid discharge apparatus according to claim 1,
wherein the air outlet is disposed on the upstream side of the nozzle face in the conveyance direction and on both sides of the nozzle face in the axial direction.

9. An image forming apparatus comprising:
the liquid discharge apparatus according to claim 1,
wherein the liquid discharge apparatus further includes a conveyor to convey the medium to the liquid discharge head in the conveyance direction.

10. A liquid discharge apparatus comprising:
a liquid discharge head having a nozzle face having multiple nozzles to discharge a liquid, in a discharge direction, from the multiple nozzles onto a medium, conveyed in a conveyance direction orthogonal to the discharge direction;
a carriage to move the liquid discharge head in a scanning direction orthogonal to the discharge direction and the conveyance direction;
a cross flow fan on a downstream side of the liquid discharge head in the scanning direction,
the cross flow fan including:
a cylindrical rotary blade having a rotation axis extending in the conveyance direction,
the cylindrical rotary blade to generate flow of air to be blown onto the medium; and
a duct covering the cylindrical rotary blade and extending downward from the cylindrical rotary blade to the nozzle face to guide the air toward the medium,
the duct having:
an air inlet having an opening disposed on the downstream side of the cylindrical rotary blade in the scanning direction,
to take in the air from the air inlet toward the cylindrical rotary blade; and
an air outlet below the air inlet to blow the air toward the medium to form an air curtain on the downstream side of the liquid discharge head in the scanning direction.

11. The liquid discharge apparatus according to claim 10,
wherein the air outlet is disposed on or above a plane extended from the nozzle face in the scanning direction.

12. The liquid discharge apparatus according to claim 10,
wherein the duct has a bent portion:
having the air outlet on a bottom of bent portion; and
bent at a lower end the duct, and
the bent portion blows the air in a blowing direction:
inclined with respect to the discharge direction; and
toward an upstream side of the cylindrical rotary blade in the scanning direction.

13. The liquid discharge apparatus according to claim 10,
wherein the duct has an outlet portion having the air outlet, and
the duct is inclined downstream in the scanning direction from the air outlet to incline the outlet portion upstream in the scanning direction with respect to the nozzle face.

14. The liquid discharge apparatus according to claim 10, further comprising multiple liquid discharge heads including the liquid discharge head,
wherein the duct includes multiple branch ducts to distribute the air from the cross flow fan to the multiple liquid discharge heads via the multiple branch ducts.

15. The liquid discharge apparatus according to claim 10,
wherein the duct has multiple ribs on an inner face of the duct, and
each of the multiple ribs extends in a direction of the air flowing in the duct.

16. The liquid discharge apparatus according to claim 15,
wherein the multiple ribs extend to the air outlet.

17. The liquid discharge apparatus according to claim 10,
wherein the air outlet is disposed on the downstream side of the nozzle face in the scanning direction and on both sides of the nozzle face in the conveyance direction.

18. An image forming apparatus comprising:
the liquid discharge apparatus according to claim 10,
wherein the liquid discharge apparatus further includes:
a conveyor to convey the medium to the liquid discharge head in the conveyance direction; and
a guide rail extending in the scanning direction, and
the carriage is attached to the guide rail to move along the guide rail in the scanning direction.
